(19) United States
(12) Patent Application Publication
(10) Pub. No.: US 2009/0299891 A1
(43) Pub. Date: Dec. 3, 2009

(54) SYSTEM AND METHOD FOR MANAGING ELECTRONIC TRADING CARDS

(75) Inventors: Mark Sapir, New York, NY (US); Warren Friss, Westfield, NJ (US)

Correspondence Address: DARBY & DARBY P.C., P.O. BOX 770, Church Street Station, New York, NY, 10008-0770, US

(73) Assignee: The Topps Company, Inc., New York, NY (US)

(21) Appl. No.: 12/474,955

(22) Filed: May 29, 2009

Related U.S. Application Data
(60) Provisional application No. 61/057,161, filed on May 29, 2008.

(51) Int. Cl. G06Q 40/00; G06F 15/16; G06F 3/00; A63F 9/24

(52) U.S. Cl. 705/37; 709/204; 463/29

(57) ABSTRACT

A device, system, and method for acquiring, displaying, managing through an electronic binder and trading of random electronic trading cards assigned through entry of a unique code.

### CROSS REFERENCE TO RELATED APPLICATION

This application claims the benefit of U.S. Provisional Application No. 61/057,161 filed May 29, 2008.

### FIELD OF INVENTION

The present invention relates generally to an online system for acquiring, managing and trading of electronic trading cards. More specifically, a virtual sports-themed world contains electronic trading cards that exist only within the virtual environment, may be obtained by entry of unique codes, and can be collected, displayed, traded and used in game play. The electronic trading cards do not have a counterpart in the physical world, and may have statistics that are updated on a regular basis.

### BACKGROUND OF THE INVENTION

Sports and entertainment trading cards have been around for many years. Trading cards typically contain a picture of a popular sports figure, entertainment figure or famous place or event, along with a collection of personal information, statistics and/or interesting facts. Premium trading cards have been developed that include high quality lithography, printing on glossy cardboard stock with crisp color photographs on the front and/or back, various matted finishes and other combinations. Trading cards can be produced and collected for almost any type of interest, including, for example, sports such as baseball, football, hockey and soccer, as well as for television and movie actors or characters, games, science fiction and fantasy genres. Some trading cards become very valuable based on various factors including the authenticity and scarcity of the particular trading card. As a result, some trading cards include some form of holographic mark, certificate of authenticity, a serial number or the like to prevent counterfeiting.

Many of the trading cards are designed to be part of a collectible group. For instance, a set of trading cards can consist of all of the characters of Star Wars or all of the players on a baseball team during a particular year. This creates an incentive to collect all of the cards within a set and adds to the enjoyment of collecting trading cards.

Recently, there has been greater interest in electronic trading cards. The current electronic trading cards are based on actual physical trading cards that are produced by a manufacturer of trading cards. There is a one to one correspondence between the physical trading card and the electronic trading card. Electronic trading cards may be traded among collectors. One of the main problems with electronic trading cards is maintaining authenticity since the electronic trading card in many instances can be copied in the same manner as other software. This problem has been overcome in various manners though electronic “water marks” and various security procedures.

Trading cards can be bought directly from the manufacturer through an on-line website, such as etopps.com. The purchaser is given the option of having the manufacturer hold onto the physical trading card or have the physical trading card delivered to the purchaser. The user is provided with an on-line image of the trading card, and has the option of tracking the value of the trading cards in their portfolio, sell or trade the cards. However, while this system provides a forum for trading cards on-line, it is not for an electronic trading card that does not have a corresponding physical trading card.

### BRIEF DESCRIPTION OF THE DRAWINGS

The present invention is specifically disclosed in the detailed description set forth herein with respect to the accompanying drawings, wherein:

FIG. 1 is a system diagram of a network within which the invention can be implemented.

FIG. 2 shows the structure of a network device that may be used in the system for implementing the invention.

FIG. 3 is a one embodiment of a registration page for the system and method of managing electronic trading cards.

FIG. 4 is one embodiment of a user's home page for the system and method of managing electronic trading cards.

FIG. 5 is one embodiment of a user's binder turned to the today's lineup section for the system and method of managing electronic trading cards.

FIG. 6 is one embodiment of a user's binder displaying all of the user's current collection of trading cards for the system and method of managing electronic trading cards.

FIG. 7 is the front of an electronic trading card for the system and method of managing electronic trading cards.

FIG. 8 is the back of an electronic trading card for the system and method of managing electronic trading cards.

FIG. 9 is one embodiment of a user's binder turned to the favorites section for the system and method of managing electronic trading cards.

FIG. 10 is one embodiment of a user's binder turned to the friends section for the system and method of managing electronic trading cards.

FIG. 11 is one embodiment of the trading section for the system and method of managing electronic trading cards.

FIG. 12 is one embodiment of the trading section, with two cards selected, for the system and method of managing electronic trading cards.

FIG. 13 is the games section for the system and method of managing electronic trading cards.

FIG. 14 is one possible game that uses the electronic trading cards for the system and method of managing electronic trading cards.

FIG. 15 is one embodiment of a webpage for use in purchasing items in the system and method of managing electronic trading cards.

### DETAILED DESCRIPTION

Certain embodiments of the invention are described more specifically with reference to the accompanying drawings. The invention may be embodied in many different forms and should not be construed as limited to the embodiments described herein. Rather, the embodiments may take different forms, such as entirely implemented through hardware, through hardware combined with software or entirely through software. Throughout this description, the various embodiments are not intended to be limiting unless so specified. References to one embodiment or another embodiment are intended to be interchangeable such that aspects of different embodiments may be combined in various ways to implement the disclosed invention.

### Environment for Implementing the Invention

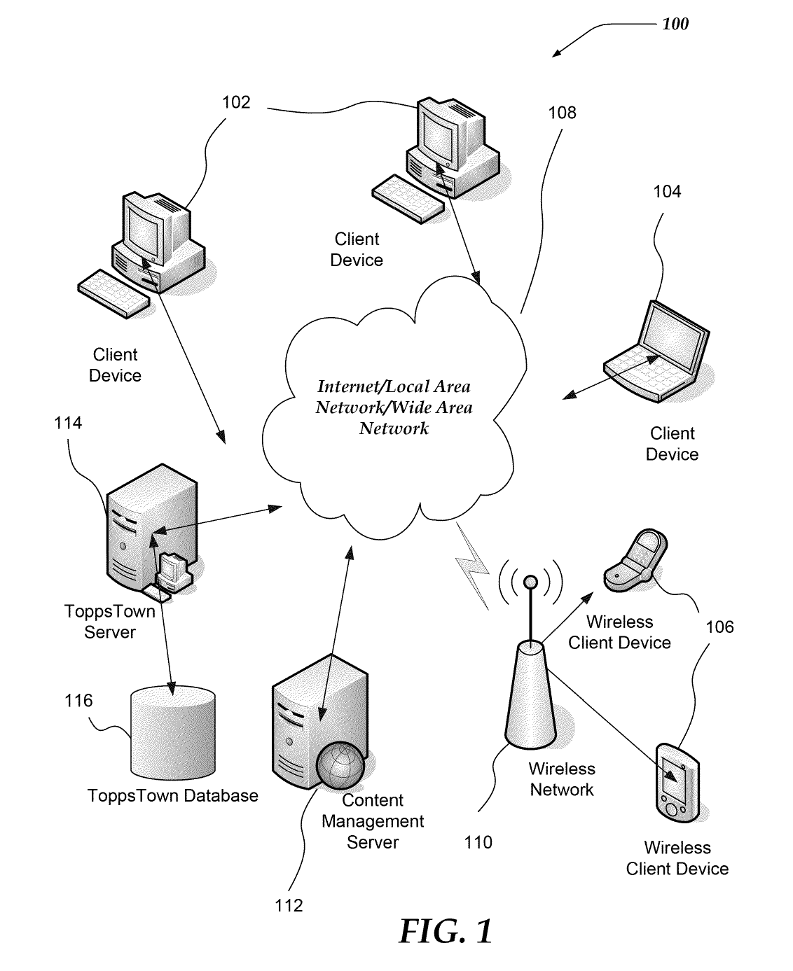

Network 100 is shown in FIG. 1. Not all of the components are required for any given implementation of the invention, and variations in the arrangement and types of components may be made without departing from the scope of the invention. As shown in FIG. 1, client devices 102, 104 can consist of personal computers, laptop computers and any other device capable of establishing a communication link with Internet/Local Area Network/Wide Area Network 108 through a wired communications medium. Client devices 102, 104 may be linked to other Wide Area Networks and/or Local Area Networks. Client devices may also consist of wireless client devices 106 such as cell phones, personal digital assistants, laptop computers, hand held computers and similar devices. Wireless client devices 106 are connected to Internet/Local Area Network/Wide Area Network 108 through wireless network 110. The client devices are capable of identifying their location to other devices within the various networks. For example, cellular phones can identify themselves through Mobile Identification Numbers, Electronic Serial Numbers or mobile phone numbers. Computer devices can identify themselves through network addresses or other device identifiers. The identifier information may be included in messages or information sent to other devices within the various networks so that communications can take place through the network between the devices. Such communication can take place through known communication methods such as Short Messaging Service (SMS), Multimedia Message Service (MMS), Instant Messaging (IM), Internet Relay Chat (IRC), Jabber or the like. Any suitable protocol or method of communication can be used to implement the current invention.

The client devices may include application programs that send and receive web-pages, web-based messages, data, packets having content for updating graphics on a client device and the like. The application programs may be browsers and associated programs that send, receive and display graphics, text, sound and multimedia. The client devices may have operating systems that enable the application programs, and use various protocols/languages to enable the web-based application programs such as Handheld Device Markup Language (HDML), HyperText Markup Language (HTML), JavaScript, eXtensible Markup Language (XML), and the like.

The various networks may also include network devices that provide content to users such as content management server 112. These devices are capable of sending and receiving text, photographs, web pages, multimedia information, and the like. These network devices provide substance of interest to users of Internet/Local Area Network/Wide Area Network 108.

Internet/local area server/wide area server 108 can couple ToppsTown Server 114 to other computing devices including client devices 102, 104, wireless client devices 106 and Content Management Server 112. ToppsTown Server 114 can be configured to provide web pages with sufficient detail to create a virtual world to users of client devices 102, 104 and 106. ToppsTown Server 114 can draw content from Content Management Server 112 in implementing this invention. Internet/local area server/wide area server 108 can use any form of computer readable media for communicating with the various electronic devices. The connections between the electronic devices can be through twisted pair, coax, fiber optics, satellite, carrier waves or any other commonly known medium. The communications can take place through routers and other networking equipment in a conventional manner. Further, the communications can have dynamic architectures and use any of a number of known protocols for communication.

ToppsTown Server 114 may include any type of computing device capable of networking with Internet/Local Area Network/Wide Area Network 108 and enabled to manage a web site (a collection of web pages) and communication with and between users of the web site. In one embodiment, ToppsTown Server is connected with ToppsTown Database which stores data used by or received from users of the ToppsTown Server. In another embodiment, the data storage takes place within ToppsTown Server 114.

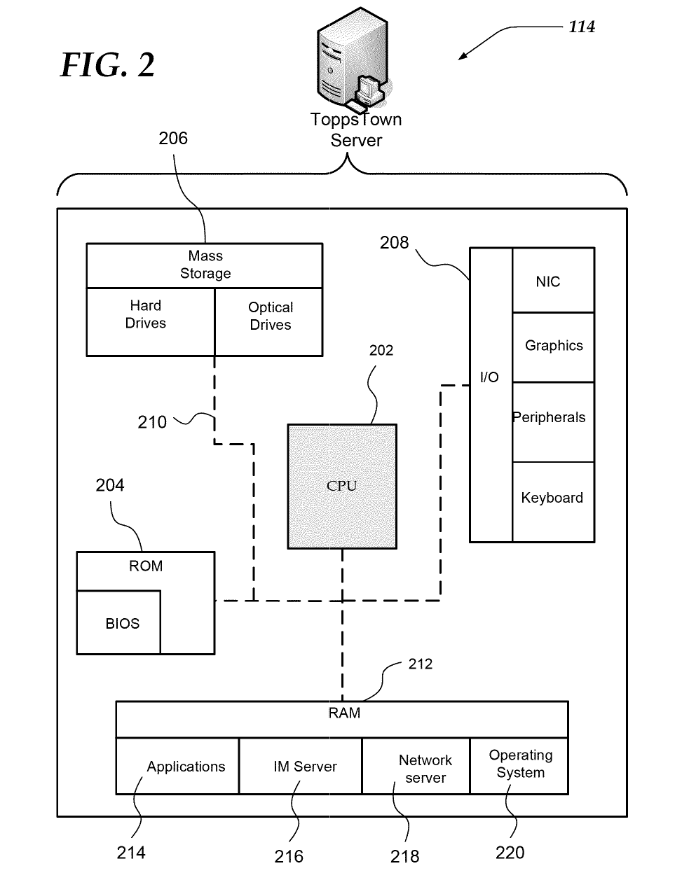

FIG. 2 shows one embodiment of a network device that can be used as ToppsTown Server 114. The network device includes central processing unit 202, input/output interface 208, ROM 204, RAM 212 and mass storage device 206. The various components are interconnected by bus 210. ROM 204 may include a Basic Input/Output System (BIOS) for controlling the low level operation of the network device. Ram 212 can contain various operating programs such as applications 214, Instant Message server 216, network server application 218 and operating system 220. Applications 214 can include the programs for implementing the current invention. For example, the applications in conjunction with network server 218 can receive the requests to trade the electronic trading cards sent by the user, can determine whether a trade is accepted by both parties, exchange the electronic trading cards between the users and update the user's trading card binder. The applications may also interface with other network devices to provide real-time or near real-time updates of the statistics for the players associated with the electronic trading cards and provide those statistics to the users.

The network device of FIG. 2 may also contain mass storage 206 which can be hard drives, optical drives, memory chips or similar devices for storing large quantities of data in non-volatile memory. Mass storage 206 may also store other program code and data. One or more applications 214 may be stored in mass storage 206 and then run within the environment of operating system 220.

The network device communicates through Input/Output device 208. Input/Output device 208 can constitute a number of separate devices. For instance, it may contain a network interface card, graphics card, peripheral controllers and the like. The server may also have a monitor and keyboard. The network device can communicate with a network, such as Internet/Local Area Network/Wide Area Network 108, through a network interface card using various communication protocols including TCP/IP protocol.

The invention can be implemented in several different ways. For example, the invention can be implemented through a traditional client server arrangement or a peer to peer network architecture. The application program can be implemented in client devices, network-devices or any combination of various devices.

### General Operation

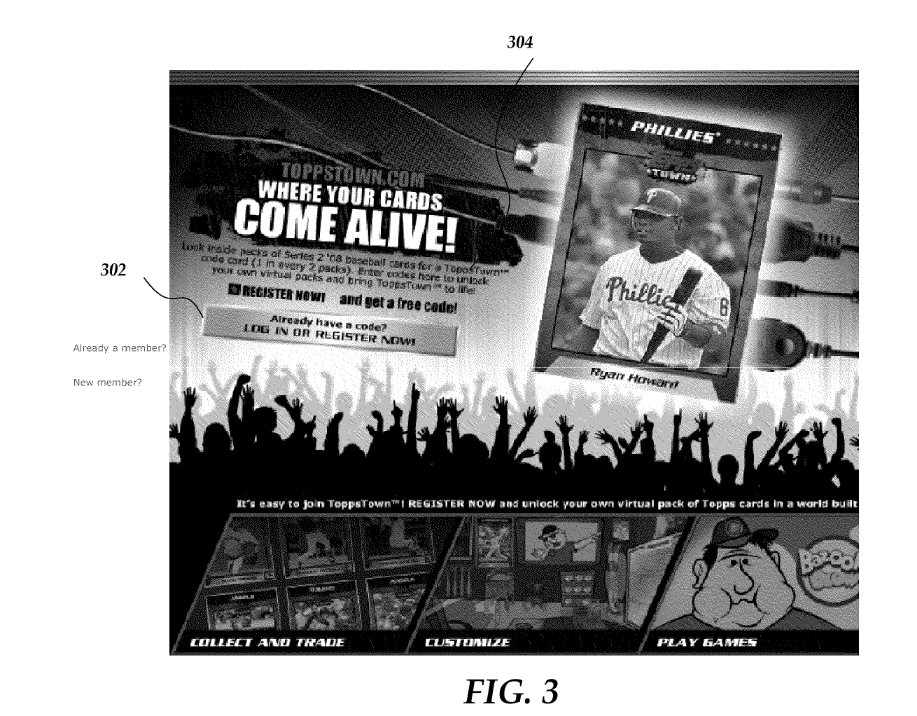

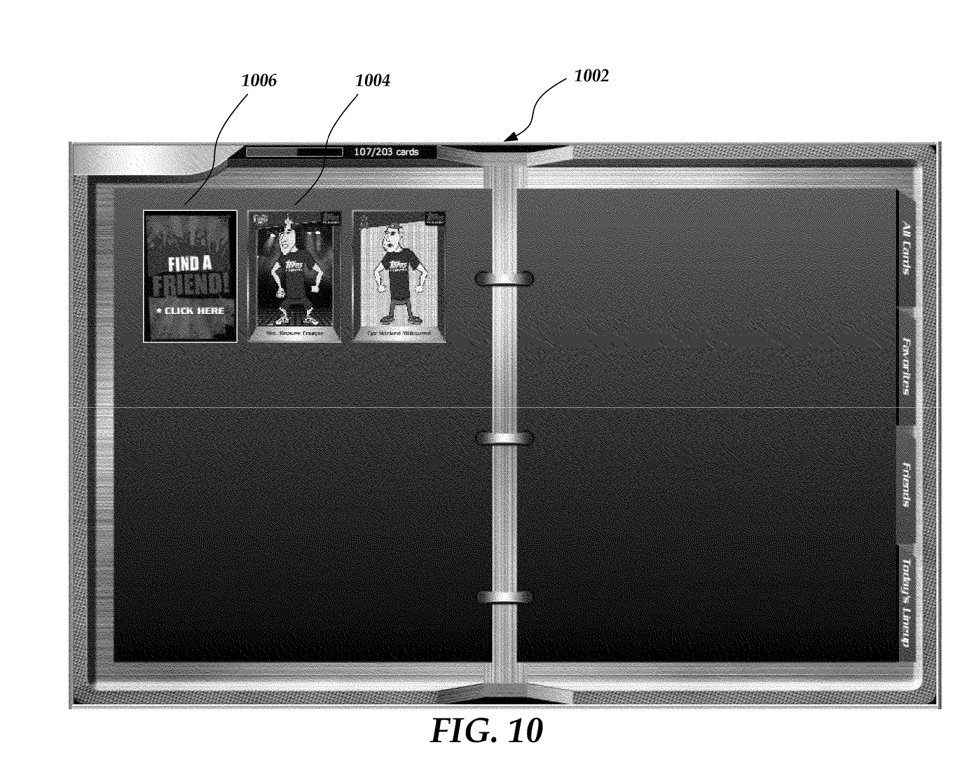

The general operation of one embodiment of the invention will be described with respect to FIGS. 3 through 15. This description is not intended to be limiting but only exemplary.

FIG. 3 shows one example of a registration web page for the invention. A user selects log in or register now button 302, which would provide an opportunity for the user to either register with the system by providing log-in information such as, for example, a user name, password and e-mail address, or to provide previously existing log-in information. By simply registering, a user may get a code that can be used to obtain electronic trading cards as shown by offer 304.

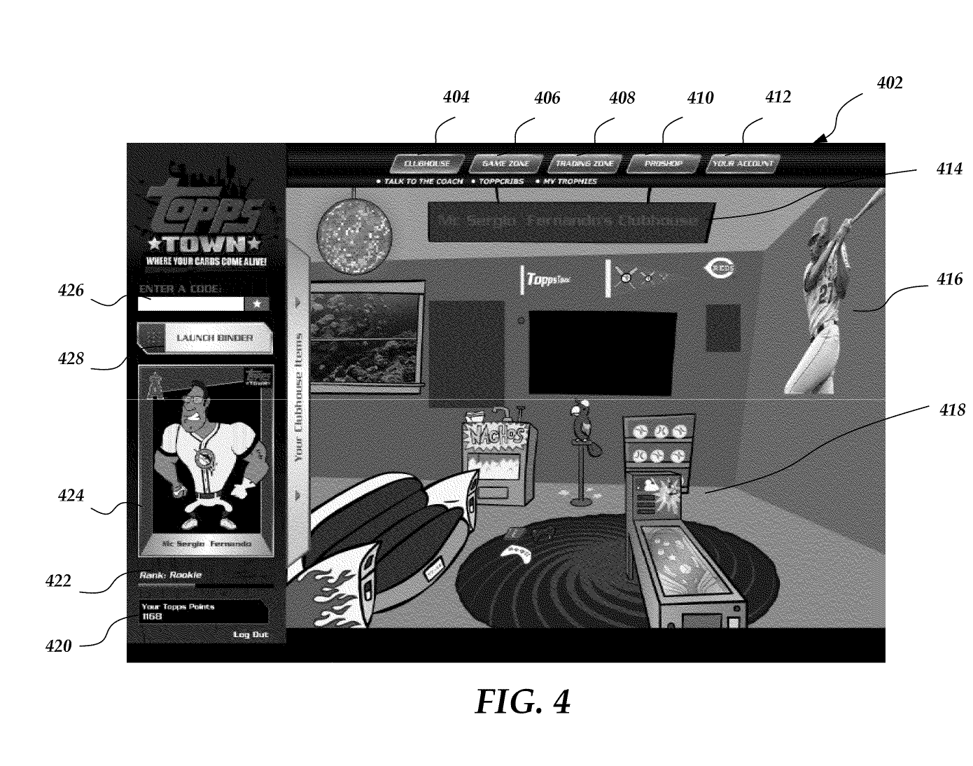

After the user is registered with the system, the user is presented with a personalized webpage or clubhouse page 402 as shown in FIG. 4. The user can return to clubhouse page 402 by clicking on clubhouse button 404. Likewise, the user can access additional web pages by clicking on game zone button 406, trading zone button 408, pro shop button 410 and your account button 412. The user can personalize clubhouse page 402 by including different items such as poster 416 or furniture 418.

The user is provided with avatar 424 which can be personalized. The avatar is provided with rank 422 that may depend on various factors such as, for example, the amount of time registered, the number of electronic trading cards that the user has, the number of points acquired, the number of trades made or the like. The user may also collect Topps points 420 for engaging in various activities such as game playing, trading or the like.

The user can obtain electronic trading cards by entering a unique code into the prompt 426. The unique code may be a number, alphanumeric code or the like. The unique code may be provided to users within a pack of physical trading cards by placing the code on one of the trading cards, on several trading cards, on a blank trading card specifically made for such purpose or on an insert card that would not be considered a trading card but may nevertheless by included in a package of trading cards. The unique code may also be provided by including the number within confectionary products, through promotional efforts such as, for example by the act of simply registering with the system or even placing a code on one of the electronic trading cards.

Once the unique code is entered, a user is provided with a set of electronic trading cards, which may range from a single electronic trading card to any number of electronic trading cards. The user may also be presented with various other electronic items, such as items for their clubhouse, ToppsTown points or the like as described herein. Typically, a user would be provided with eight electronic trading cards with each unique code. The electronic trading cards will be placed within an electronic binder, which can be accessed by clicking on launch binder button 428.

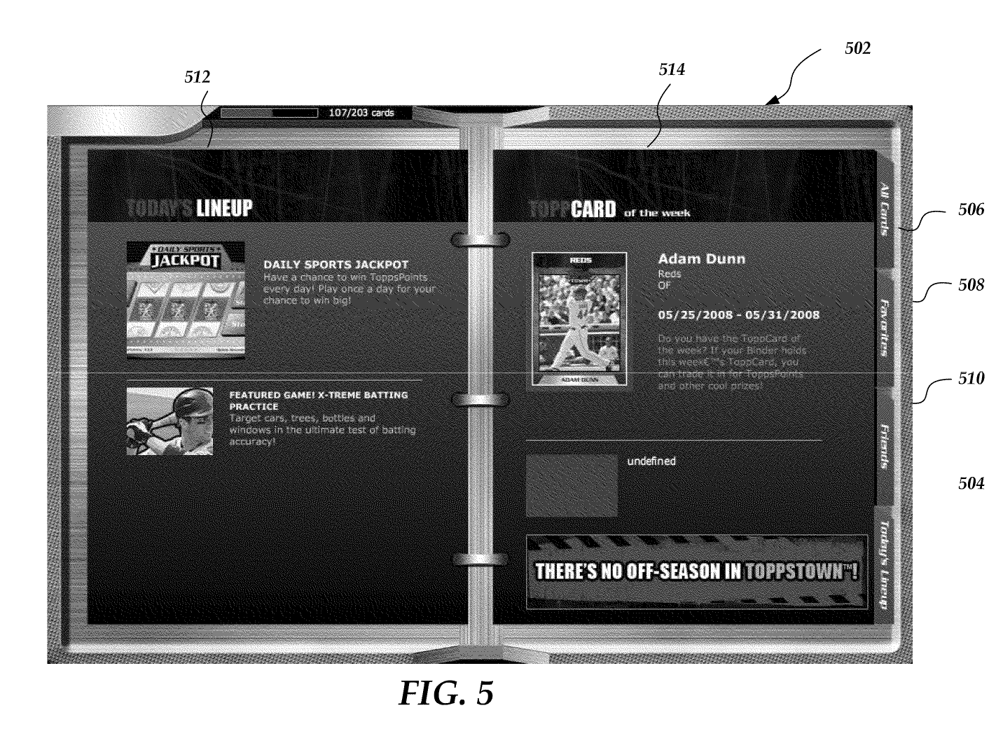

Electronic binder 502 may appear as an electronic rendition of a real binder as shown in FIG. 5. The binder may have tab sections for accessing different portions of electronic binder 502, as shown by all cards tab 506, favorites tab 508, friends tab 510 and today's lineup 504. In FIG. 5, the binder is shown turned to the today's lineup section in which daily events may be highlighted as indicated by daily sports jackpot 512 and may have additional specials, such as card of the week 514.

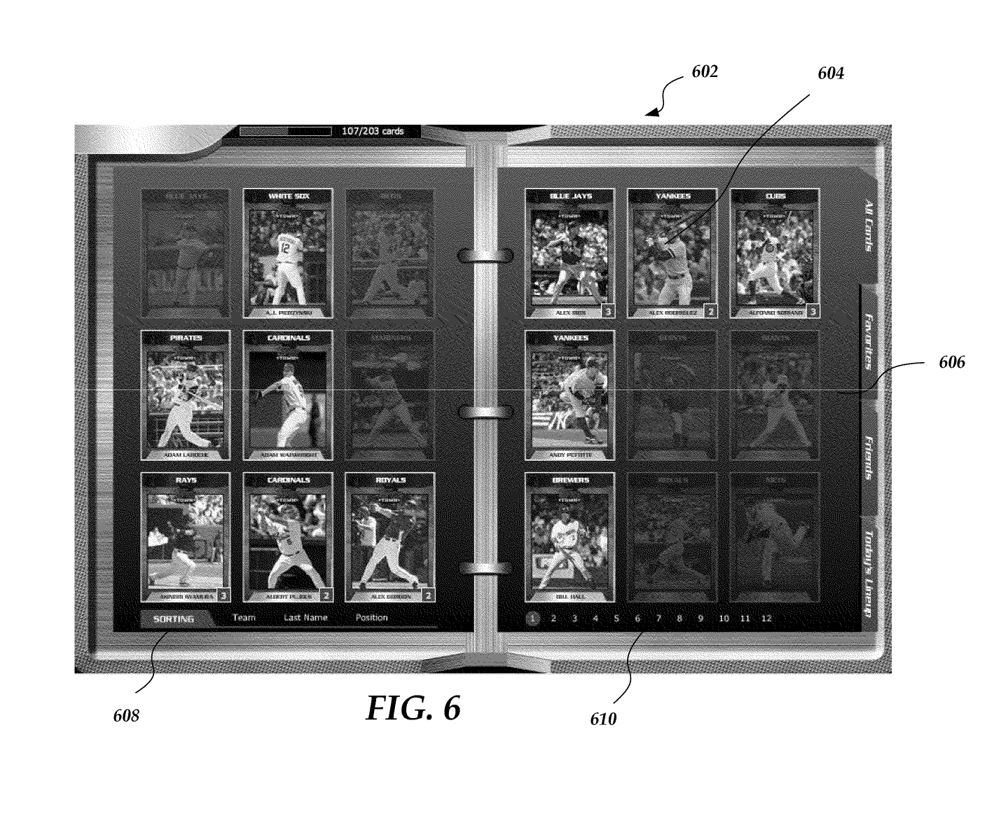

The user can view the cards within their collection by clicking on all cards tab 506. This will bring the user to all cards section 602 as shown in FIG. 6. The cards that are in the user's collection are shown by the images, such as Alex Rodriguez electronic trading card 604. The cards that are not in the user's collection, but that exist within the system, are shown as grayed-out or faded images, such as shown by grayed-out image 606. The user may “flip” the pages of the binder by selecting from the page from page number bar 610, and may sort their electronic trading cards by different criteria, such as, for example, by team, last name or position. These can be accessed by clicking on sorting criteria button 608. The trading cards may also be manually sorted by the user in various manner, for example, by dragging and dropping the trading card within the binder “slots.” For electronic trading cards in which there is more than one, there is an indication of the number of such trading cards in the electronic binder by the number in the lower right corner of each electronic trading card.

In one embodiment, the electronic trading cards may exist only within the system. That is, the electronic trading cards reside within, for example, ToppsTown server 114 and cannot be downloaded to a user's computer where it can be copied or modified. This assures the authenticity of the electronic trading card. The electronic trading card may exist as a full data file or may consist of links to other data files or data resources.

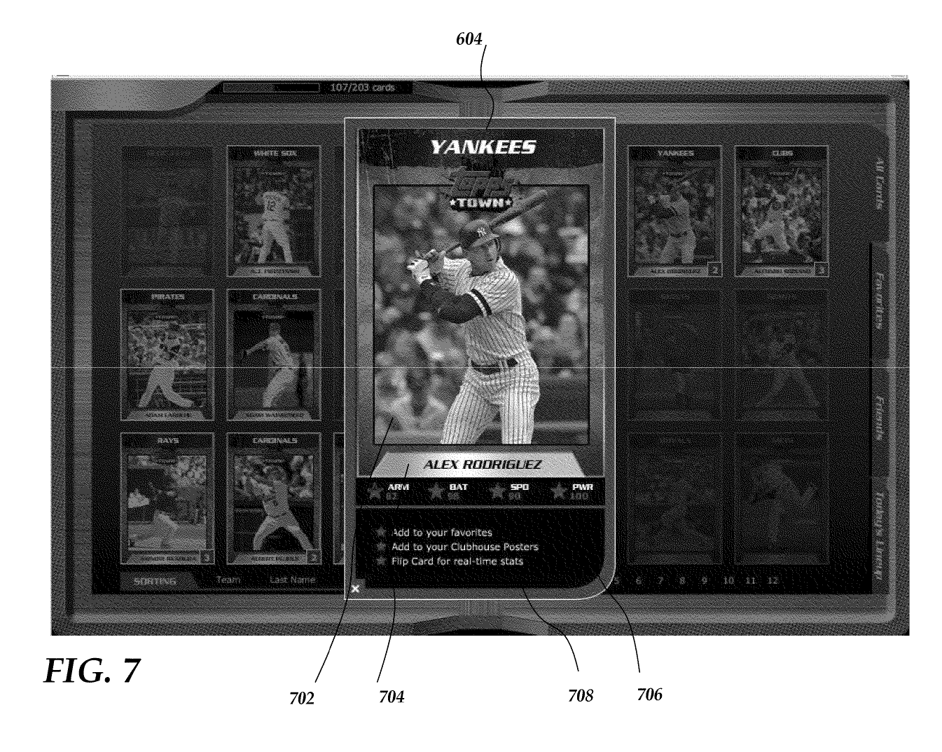

A user may view the trading card by clicking on the trading card itself. As an example, if the user clicks on Alex Rodriguez trading card 604, a larger image of the electronic trading card will be provided to the user as shown in FIG. 7. The electronic trading card may contain a picture of the player, as shown by picture 702. This picture may be a single picture or rendition of the player taken or created on a particular day. In an alternative embodiment, the picture or rendition may be updated on a regular basis, such as yearly, monthly, weekly or even daily. In one embodiment, the user may have the option of freezing or even selecting the picture for the electronic trading card. In another embodiment, the picture or rendition on the electronic trading card may consist of moving pictures or clips. The electronic trading card will also have typical indicia of trading cards such as, for example, player name 704. The electronic trading card may or may not replicate a pre-existing physical trading card. The electronic trading card may also have statistics for use in game play. Game play statistics 706 may have statistics such as “arm”, “bat”, “spd” or “pwr” having values that may be used in games within the system as described herein. The statistics can have any number of values. The user may also have various actions that they can take with the electronic trading card such as adding the electronic trading card to their favorites, adding the picture to the clubhouse poster or “flipping” the electronic trading card to its other by selecting one of the options 708.

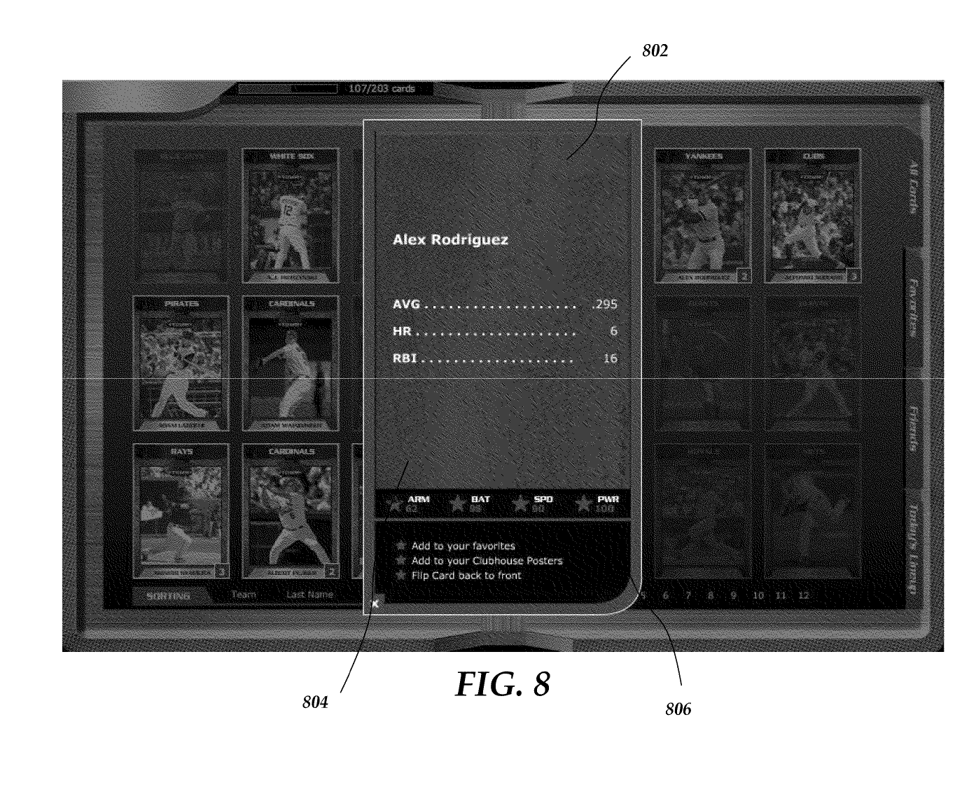

As shown in FIG. 8, when the option to flip the card is selected, the “back” of the electronic trading card is shown. The back of the electronic trading card may contain statistics 806 for the player. These statistics may be for the player for a particular period of time or year, or the statistics may be updated yearly, monthly or after every game or even on a real-time or near real-time basis. The statistics may be obtained from content management servers 112 (FIG. 1) or may be compiled by ToppsTown server 114. These statistics may also be linked to game play statistics 706. As one example, as the players batting average increases, the game play statistics associated with batting may increase. As another example, a combination of the player's real time statistics may either increase or decrease the various game play statistics.

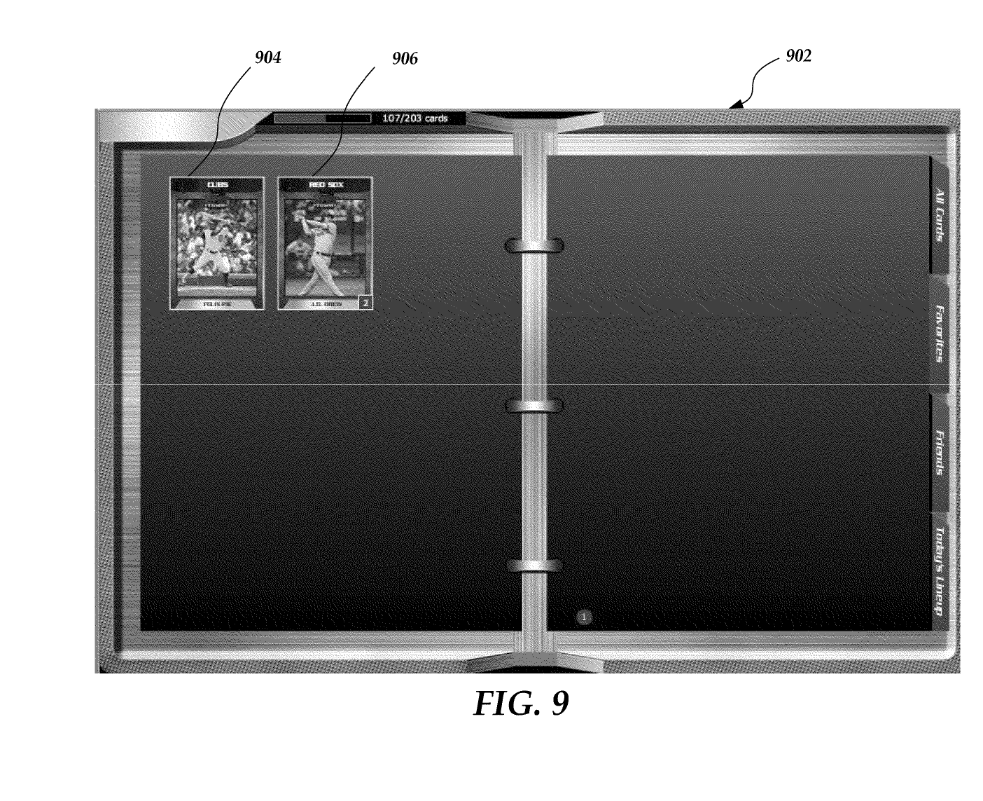

The user may place electronic trading cards into the favorites section 902 as shown in FIG. 9. In this example, electronic trading cards 904 and 906 are in the favorites section. Electronic binder may also have friends section 1002. The friends of the user may be represented by including pictures of their avatars as shown by picture 1004. Other users can be found by clicking on find a friend button 1006.

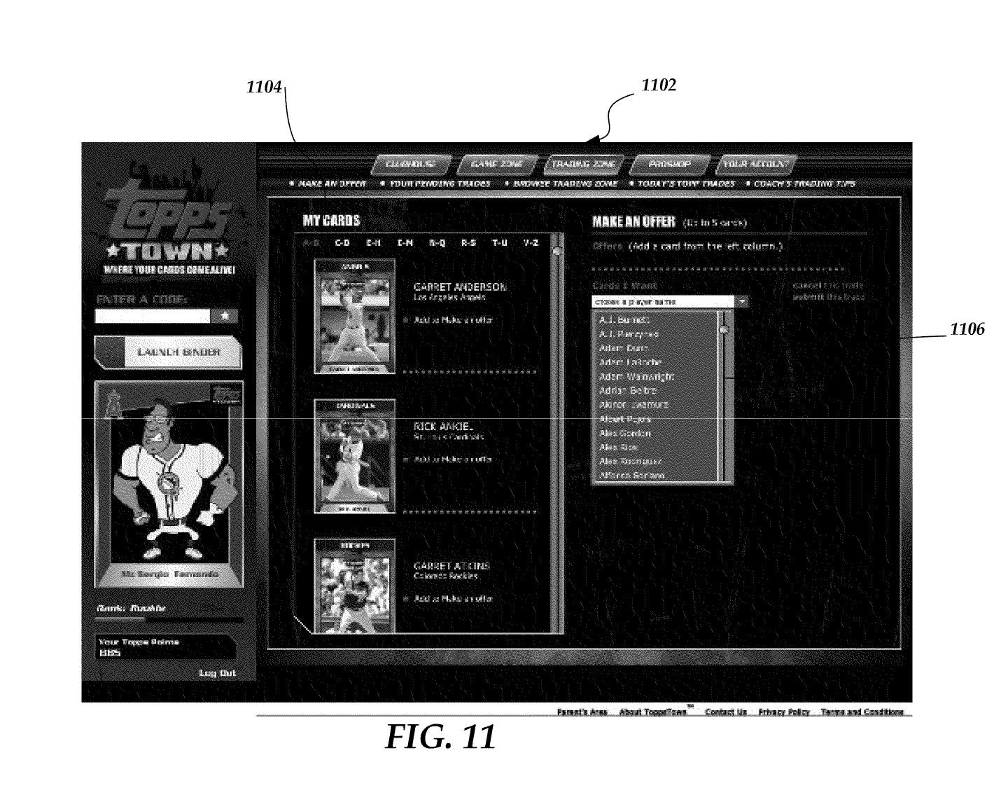

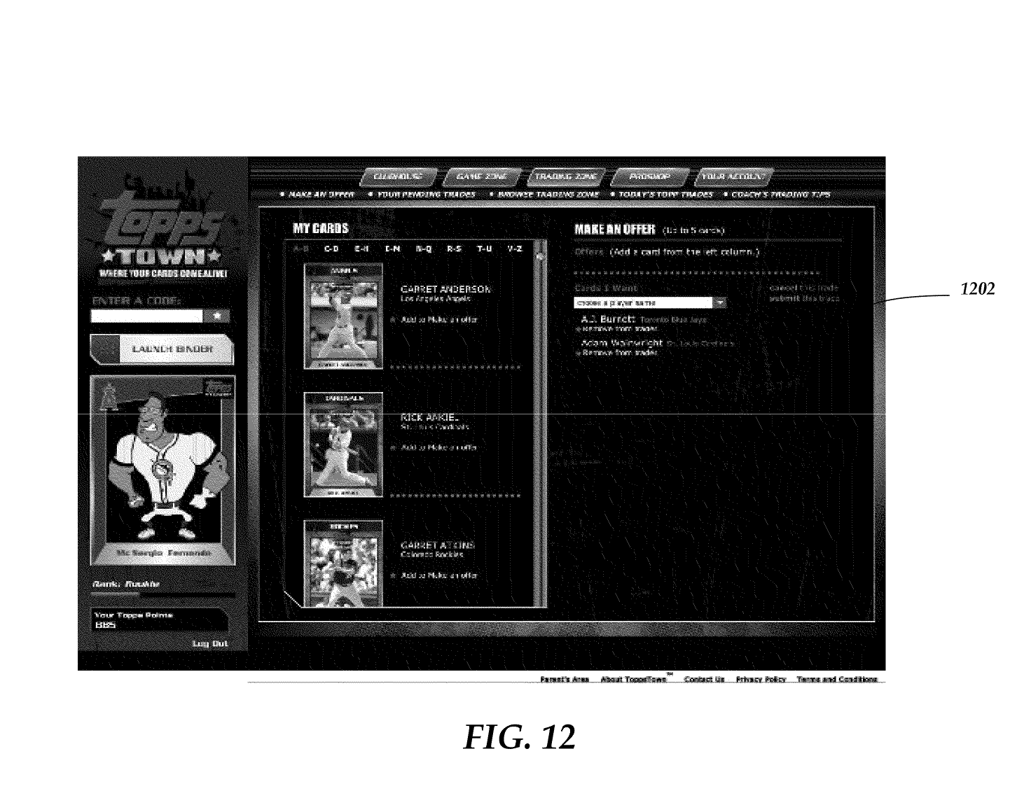

A user may trade the electronic trading cards through trading zone 1102 as shown in FIG. 11. The trading zone may be accessed, for example, through trading zone button 408 from club house page 402. In trading zone 1102, the user has their current cards listed and may make an offer for a trade by selecting one or more electronic trading cards that the wish to trade. The user then selects the players that they want, as for example by selecting from drop down list 1106. The offer for a trade may be 1 player for 1 player, 1 player for two players or the like. FIG. 12 shows selection 1202 of two players for trading. Once there is agreement on a trade, the system completes the trade by swapping the electronic trading cards between the users. There may be any number of alternative methods of promoting the trading of electronic trading cards between users. As another example, a user may be provided with a list of electronic trading cards that other users are willing to trade, and the user will select the electronic trading card that they wish to obtain and select the cards that they are willing to trade for it. Alternatively, a user can conduct a search for the particular player they are seeking, and the system may only present those users willing to trade that particular player who are seeking electronic trading cards that the user has in his possession. As yet another example, the electronic trading cards may be exchanged for ToppsTown points, avatar items, club house items or for other items collected or acquired within the system.

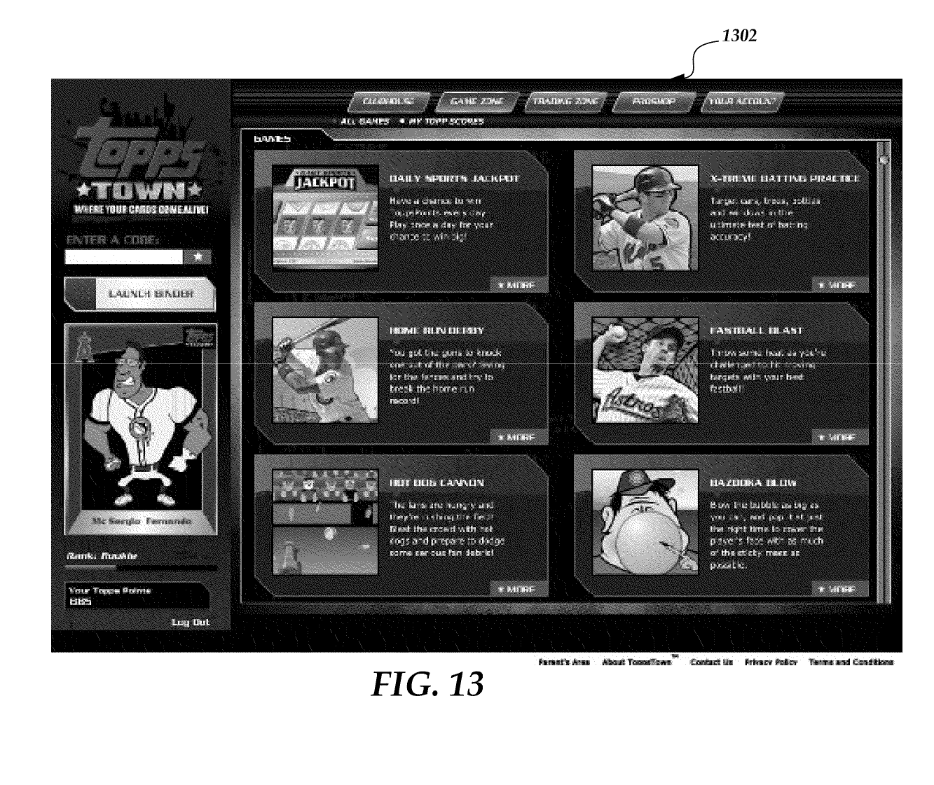

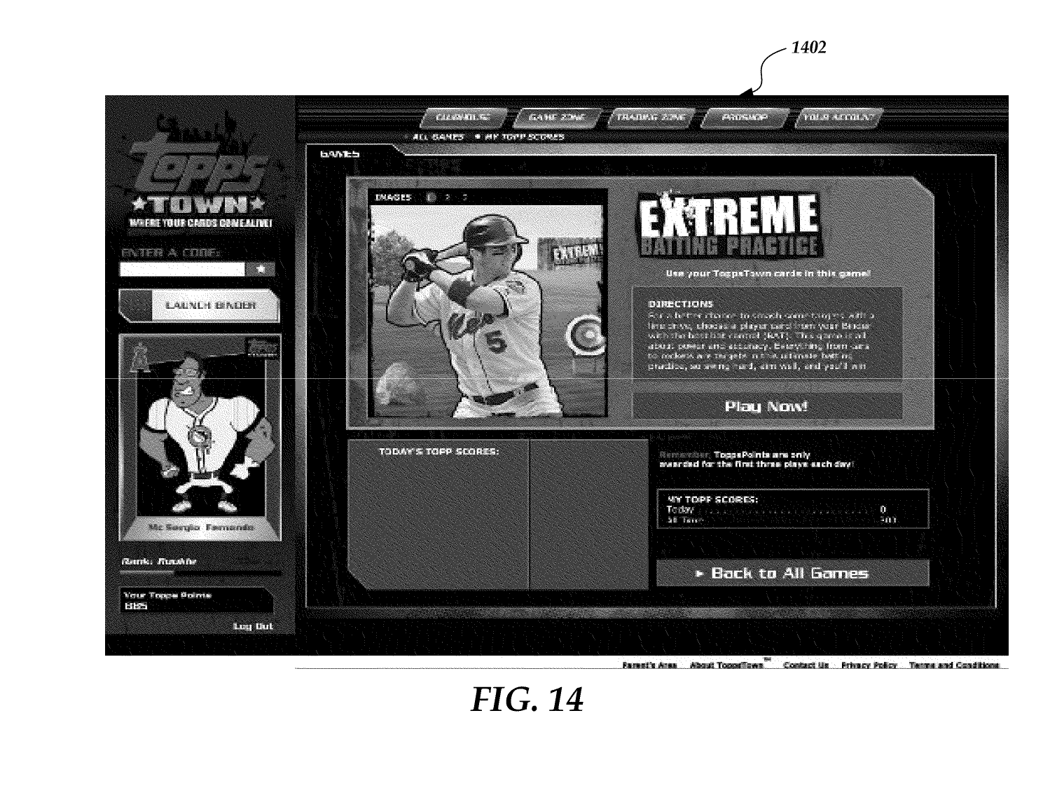

The user may also engage in various activities through the system, such as games as shown in FIG. 13. The playing of these games may cause them to accumulate ToppsTown points. These games may all be thematically related to the electronic trading cards. One example would be to include a fantasy league in which the players on the electronic trading cards within the user's binder may be chosen to form the team. The team may then participate in a fantasy league, within the ToppsTown system, based on either the statistics for the trading cards (whether or not the statistics are real time) or the game play statistics. Another example is shown in FIG. 14. In FIG. 14, extreme batting practice 1402 is launched. In this game, the user has the option of selecting an electronic trading card to use in the game. If the electronic trading card is used, then the game play statistics are used in the game. In this example, the user controls the direction that the ball will travel and the power applied to the bat in hitting the ball. If the game play statistics for the selected electronic trading card has a high “pwr” value, then the game will be played wherein the power applied to the bat in hitting the ball will be greater. The game player statistics may be used in any combination of ways to enhance the game play of the user.

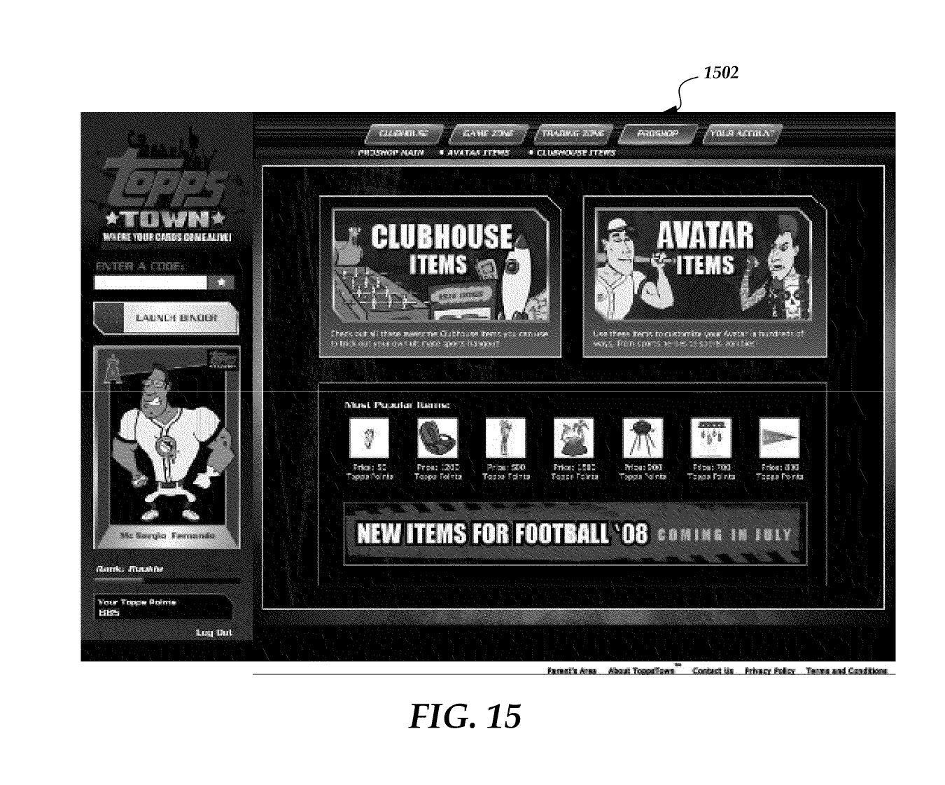

The user may also have access to pro shop page 1502, as shown in FIG. 15. On this page, the user may purchase or trade clubhouse items, avatar items or other items within the ToppsTown system.

The method and system provides an additional dimension to the experience of collecting of trading cards by creating a virtual world within which collecting and trading of electronic cards can take place.

The present invention may be applied to any number of different sports and may also extend to trading cards for entertainment and role playing games.

What is claimed as new and desired to be protected is:

1. A network device to manage communications over a network, comprising:
a transceiver to send and receive data over a network; and
a processor that is operative to enable actions for:
generating an account;
receiving a unique code in association with the account; and
assigning a set of random electronic trading cards to the account in response to entry of the unique code, wherein the set of random electronic trading cards has no association with corresponding physical trading cards.

2. The network device of claim 1, wherein the processor is operative to enable further actions comprising:
generating a display of an electronic binder containing at least one binder page that has predetermined space for two or more electronic trading cards; and
generating an image of at least one of the set of random electronic trading cards in the predetermined space of the electronic binder.

3. The network device of claim 1, wherein the processor is operative to enable further actions comprising:
generating a list of electronic trading cards available for trading from a set of electronic trading cards assigned to one or more other accounts;
receiving a request to trade one or more of the set of electronic trading cards assigned to the account for one or more of the electronic trading cards available for trading; and
exchanging the assignment of one or more of the set of random electronic trading cards for one or more of the electronic trading cards available for trading between the account and the one or more other accounts.

4. The network device of claim 1, wherein the predetermined space for two or more electronic trading cards contains a grayed-out image of an electronic trading card not assigned to the account.

5. The network device of claim 1, wherein the processor is operative to enable further actions comprising:
providing a moving picture in association with the electronic trading card.

6. The network device of claim 1, wherein the processor is operative to enable further actions comprising:
providing near-real time statistics in association with the electronic trading card.

7. The network device of claim 1, wherein the processor is operative to enable further actions comprising:
generating a game play environment;
receiving a request to use one or more of the set of electronic trading cards within the game play environment;
utilizing statistics associated with the one or more of the set of electronic trading cards within the game play environment.

8. A method for managing communications over a network, comprising:
generating an account;
receiving a unique code in association with the account;
assigning a set of random electronic trading cards to the account in response to entry of the unique code, wherein the set of electronic trading cards has no association with corresponding physical trading cards;
generating a list of electronic trading cards available for trading from a set of electronic trading cards assigned to one or more other accounts;
receiving a request to trade one or more of the set of random electronic trading cards assigned to the account for one or more of the electronic trading cards available for trading; and
exchanging the assignment of one or more of the set of electronic trading cards for one or more of the electronic trading cards available for trading between the account and the one or more other accounts.

9. The method of claim 8, further comprising:
generating a display of an electronic binder containing at least one binder page that has predetermined space for two or more electronic trading cards; and
generating an image of at least one of the set of electronic trading cards in the predetermined space of the electronic binder.

10. The method of claim 9, wherein the predetermined space for two or more electronic trading cards contains a grayed-out image of an electronic trading card not assigned to the account.

11. The method of claim 8, further comprising:
generating a moving picture in association with the electronic trading card.

12. The method of claim 8, further comprising:
providing near-real time, continuously updated statistics in association with the electronic trading card.

13. The method of claim 8, further comprising:
generating a game play environment;
receiving a request to use one or more of the set of electronic trading cards within the game play environment;
utilizing statistics associated with the one or more of the set of electronic trading cards within the game play environment.

14. A system for communicating over a network, comprising:
a plurality of client devices, wherein each client device is configured to receive and send messages over the network; and
a network device that is in communication with the plurality of client devices, and is configured and arranged to perform actions, including:
generating an account;
receiving a unique code in association with the account;
assigning a set of random electronic trading cards to the account in response to entry of the unique code;
generating a display of an electronic binder containing at least one binder page that has predetermined space for two or more electronic trading cards; and
generating an image of at least one of the set of electronic trading cards in the space of the electronic binder.

15. The system of claim 14, wherein the network device is configured and arranged to perform further actions including:
generating a list of electronic trading cards available for trading from a set of electronic trading cards assigned to one or more other accounts;
receiving a request to trade one or more of the set of electronic trading cards assigned to the account for one or more of the electronic trading cards available for trading; and
exchanging the assignment of one or more of the set of electronic trading cards for one or more of the electronic trading cards available for trading between the account and the one or more other accounts.

16. The system of claim 14, wherein the space for two or more electronic trading cards contains a grayed-out image of an electronic trading card not assigned to the account.

17. The system of claim 14, wherein the network device is configured and arranged to perform further actions including:
providing a moving picture in association with the electronic trading card.

18. The system of claim 14, wherein the network device is configured and arranged to perform further actions including:
providing near-real time statistics in association with the electronic trading card.

19. The system of claim 14, wherein the network device is configured and arranged to perform further actions including:
generating a game play environment;
receiving a request to use one or more of the set of electronic trading cards within the game play environment; and
utilizing statistics associated with the one or more of the set of electronic trading cards within the game play environment.
